(19) United States
(12) Patent Application Publication
(10) Pub. No.: US 2025/0238938 A1
(43) Pub. Date: Jul. 24, 2025

(54) METHOD FOR TRACKING MOVEMENTS OF INDUSTRIAL MACHINES, PERCEPTION DEVICES AND ROBOTS

(71) Applicant: Continental Automotive Technologies GmbH, Hannover (DE)

(72) Inventors: Mo Shan, Singapore (SG); Michael Colin Hoy, Singapore (SG)

(73) Assignee: Continental Automotive Technologies GmbH, Hannover (DE)

(21) Appl. No.: 19/033,420

(22) Filed: Jan. 21, 2025

(30) Foreign Application Priority Data
Jan. 24, 2024 (GB) 2400905.2

(51) Int. Cl. G06T 7/246; G06T 7/11; G06T 7/60; G06T 7/73; G06T 17/00

(52) U.S. Cl. CPC G06T 7/251; G06T 7/11; G06T 7/60; G06T 7/75; G06T 17/00; G06T 2200/04; G06T 2207/10016; G06T 2207/20081; G06T 2207/20084; G06T 2207/20132; G06T 2207/30248; G06T 2210/12

(57) ABSTRACT

A computer-implemented method for tracking movements of an industrial machine includes, for each image of a sequence of two-dimensional images that captures the industrial machine: generating a first bounding box and a second bounding box, generating a three-dimensional model based on the first bounding box and the second bounding box, projecting the three-dimensional model on the image resulting in a two-dimensional projection, and optimizing pose of the three-dimensional model based on the two-dimensional projection. The first and second bounding boxes identifies a first and second component of the industrial machine, respectively. The three-dimensional model includes a first geometric shape and a second geometric shape representing the first component and the second component, respectively. The method further includes tracking movements of the industrial machine over time based on the optimized poses of the three-dimensional model for each image of the sequence.

### TECHNICAL FIELD

Various embodiments relate to methods for tracking movements of industrial machines, as well as relate to perception devices and robots.

### BACKGROUND

In logistics facilities, industrial machines often operate in proximity to other autonomous machines or human-operated machines. For example, in warehouse scenarios, cooperation between robots and human-driven forklifts is required, and as such the robots need to comprehend the semantic relationships associated with forklifts to avoid collisions while performing their designated tasks. As such, the robots may need to track movements of the forklifts, including the changes in poses of the forklifts. Existing solutions for three-dimensional (3D) object detection mostly focus on regressing the object detection from 3D point clouds. However, this approach relies on accurate point clouds measurements and is not feasible for robots without expensive 3D LiDAR sensors. These solutions also involve training neural networks with 3D data, and as such, the training dataset require annotation of 3D bounding boxes, which is often unavailable due to difficulty in annotating noisy point clouds.

### SUMMARY

According to various embodiments, there is provided a computer-implemented method for tracking movements of an industrial machine. The method includes, for each image of a sequence of two-dimensional (2D) images that captures the industrial machine: generating a first bounding box and a second bounding box, generating a 3D model based on the first bounding box and the second bounding box, projecting the 3D model on the image resulting in a 2D projection, and optimizing pose of the three-dimensional model based on the 2D projection. The first and second bounding boxes identifies a first and second component of the industrial machine, respectively. The 3D model includes a first geometric shape and a second geometric shape representing the first component and the second component, respectively. The method further includes tracking movements of the industrial machine over time based on the optimized poses of the 3D model for each image of the sequence. Unlike most known methods of tracking 3D object movements, this method may provide reliable 3D tracking using only 2D images as inputs. As such, the method may be applicable even to vehicles or robots that are not equipped with 3D sensors. The computational resources required to process the 2D images is also lower as compared to 3D tracking using 3D data.

According to various embodiments, there is provided a perception device. The perception device includes a processor configured to perform the above-described method for tracking movements of an industrial machine. The perception device may provide its outputs to a vehicle or a robot that operates in the same environment as the industrial machine, so that the vehicle or robot may cooperate with the industrial machine or avoid collisions with it.

According to various embodiments, there is provided a robot. The robot includes a camera and the above-described perception device. The camera is configured to generate the sequence of two-dimensional images.

According to various embodiments, there is provided a non-transitory computer-readable storage medium. The computer-readable storage medium includes instructions executable by at least one processor to perform the above-described method for tracking movements of an industrial machine.

According to various embodiments, there is provided a computer program. When the computer program is executed by a computer, it causes the computer to carry out the above-described method for tracking movements of an industrial machine.

Additional features for embodiments are provided in the dependent claims.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the embodiments. In the following description, various embodiments are described with reference to the following drawings, in which:

FIG. 1 shows a side view of a forklift.

FIG. 2 shows the reprojection of cuboid points to a 2D image.

FIG. 3 shows a flow diagram of a computer-implemented method for tracking movements of an industrial machine according to various embodiments.

FIG. 4 shows a block diagram of a perception device according to various embodiments.

FIG. 5 shows a block diagram of a robot according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the invention may be readily understood and put into practical effect, various embodiments will now be described by way of examples and not limitations, and with reference to the figures.

According to various embodiments, a method for tracking movements of an industrial machine may be provided. The method may identify the poses of the industrial machine, and by tracking the changes in poses of the industrial machine, track the movement of the industrial machine. The method may be suited for tracking movements of industrial machines that have coupled parts. For ease of explanation, the method is described herein in relation to a forklift, which has a body and a tine coupled to the body. The method may also be applied to other types of industrial machines that have coupled parts, such as pallet stackers, cobots, aerial work platforms, among others. The method may be carried out by warehouse robots that need to detect and track other industrial machinery operating in the same place.

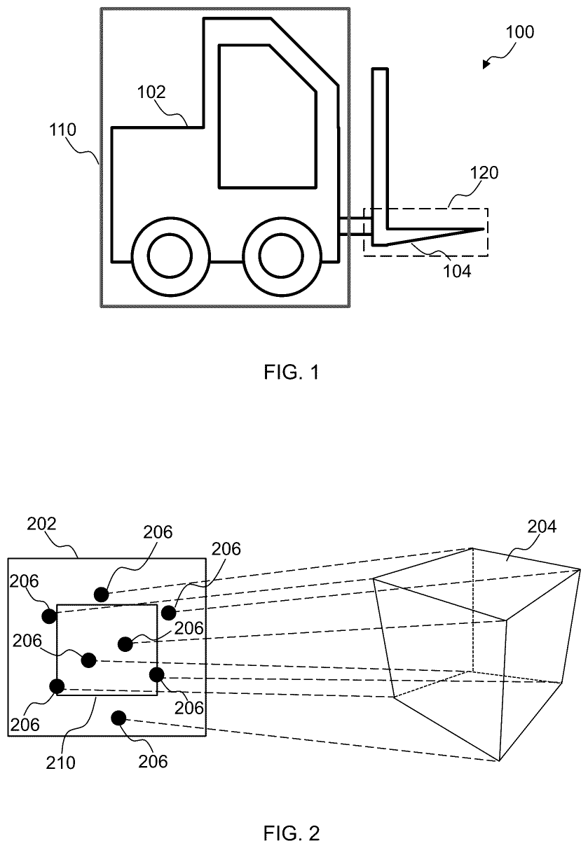

FIG. 1 shows a side view of a forklift 100. A machine, such as a robot or an autonomous vehicle, that operates in the same premises as the forklift may be equipped with a perception device. A camera mounted on the machine or otherwise positioned in the premises, may be configured to capture images of the forklift 100. The perception device may process the captured images in real time, to thereby determine the movements of the forklift 100. The perception device may model the forklift 100 as a compound shape that includes a plurality of geometric shapes. For example, the compound shape may include a cuboid that models the body 102 of the forklift 100, and the compound shape may further include an ellipsoid that models the tine 104, or vice-versa.

The tracking of the forklift 100 may be formulated as a non-linear optimization problem. Several heuristics may be introduced to customize the tracking method specifically for forklifts 100. The body 102 may be modelled as a cuboid, parameterized as c=(θ, t₁, t₂, t₃, d₁, d₂, d₃)∈ [symbol] , where θ represents the yaw angle of the cuboid, t₁, t₂, t₃ represent the translation of the cuboid in 3D in the camera frame, while d₁, d₂, d₃ represent the length, width and height of the cuboid respectively. The pitch and roll angles are assumed to be zero. The tine 104 may be modeled as the ellipsoid 120, parameterized as q=(θ, t₁, t₂, t₃, s₁, s₂, s₃)∈ [symbol] , where θ represents the yaw angle of the tine 104, t₁, t₂, t₃ represent the translation of the tine 104 in 3D in the camera frame, while s₁, s₂, s₃ represent the radii of the ellipsoid in the three axes. The camera poses may be obtained from the odometry of the machine where the camera is mounted. In the following description, the pose of the forklift 100 in the world frame may be estimated with the current camera pose as the origin. The camera mounted on the machine, or in the premises, may capture RGB images of the object {Iₜ}, t∈1 . . . T. The objective is to optimize the cuboid and ellipsoid states based on the sensor measurements at time instance t:

$${min}_{c} . {‖ m ( {P}_{t} , {I}_{t} ) - f ( c , q ) ‖}_{r} \qquad ( 1 )$$

where ∥⋅∥ᵣ is the huber loss robust kernel to handle the outliers, m is the function that takes the measurements as inputs and outputs a bounding box, and m(Pₜ, Iₜ)−f(c, q) is a cost function.

In this context, “bounding box” refers to an imaginary rectangle that serves as a point of reference for object detection. The bounding box may mark out where an object is, in an image. The bounding box and the cost function are described in subsequent paragraphs.

A first neural network may be trained to detect the body 102 and the tine 104 of the forklift 100 in the camera images and to output bounding boxes for the body 102 and the tine 104 respectively. The first neural network is referred herein as the two-dimensional (2D) detector, and denoted as q. The 2D detector may be trained using first training data that contains images with forklifts and the annotated bounding boxes. An example of the training algorithm is “MMDetection: Open mmlab detection toolbox and benchmark” by Chen et. al, which is incorporated herein by reference. The forklift body 102 and tine 104 may be labeled and detected separately as in:

{b_{b},bₜ}=ϕ(Iₜ)

where {b_{b}, bₜ} means the output of the 2D detector (ϕ) is a set of forklift detections, each has a bounding box for body b_{b} and tine bₜ. Referring to FIG. 1, the 2D forklift detector may output a body bounding box 110 that identifies the body 102 and a tine bounding box 120 that identifies the tine 104.

A second training dataset may be constructed with camera images that are annotated with orientation and dimension information. The dataset size of the second training dataset may be increased by augmenting real data with simulation data. For example, the simulation data may be collected using the NVIDIA Isaac Sim (https://developer.nvidia.com/isaac-sim). Random cropping may be applied to simulated images to mitigate the domain gap between simulated and real data.

For a 2D detection, the region of interest I_{b} corresponding to the bounding box b_{b} of the forklift body 102 may be cropped out, then the orientation θ_{b}∈[−π, π] and dimensions d∈R³ of the forklift may be regressed using a second neural network K which takes I_{b} as input:

θ_{b},d=κ(I_{b})

In other words, the second neural network k may estimate orientation and dimensions of the forklift 100 based on the bounding boxes 110, 120 generated by the 2D detector.

The optimization problem requires a reasonable initial estimation of the state. The initial 3D position of the body 102 (denoted as tᵢ∈R³) in the camera frame may be estimated based on the body bounding box 110 (denoted as b_{b}), orientation of the forklift 100 (denoted as θ_{b}) and dimensions of the forklift 100 (denoted as d), such that the reprojection of the 3D cuboid c coincides with the 2D detection b_{b}. As the reprojected cuboid using the initial 3D position tᵢ may not correspond to the bounding box b_{b} actually observed, an extra step based on heuristics may be performed to ensure that the reprojection coincides with b_{b}.

Firstly, the magnitude of tᵢ may be calculated by dₘ=∥t₁∥₂. Secondly, suppose the middle point of the bottom line for b on the image is p_{b}, and assume the reprojection of the bottom center of c lies on the ray that passes through the camera center and p_{b}. The distance of the cuboid bottom center from the camera equals to dₘ. The refined 3D position tₚ in the world frame can be obtained via

$$[ \begin{matrix}x \\ y \\ z\end{matrix} ] = [ \begin{matrix}{d}_{m} \cdot ( u - {c}_{x} ) / {f}_{x} \\ {d}_{m} \cdot ( v - {c}_{y} ) / {f}_{y} \\ {d}_{m}\end{matrix} ] \qquad ( 2 )$$

where t_{b}=[x, y, z]^{T}, fₓ and f_{y} are the focal lengths of the camera, and cₓ, c_{y} are the coordinates of the principal point, which is the point where the optical axis intersects the image plane. Accordingly, the cuboid reprojection may overlap with the bounding box using t_{b}.

The size of the tine 104, referred herein as tine size, may be initialized based on class prior. In other words, the size of the tine 104 may be initialized based on prior information. For example, the tine size of a forklift is typically around 1.5 m. The perception device may include a memory that stores the prior information of various types of industrial machines, for example, in the form of a lookup table. The body orientation θ_{b} may provide a strong prior for the location of the tine 104, since the tine 104 is always in front of the body 102. In addition, the orientation of the tine 104 (denoted as θₜ) equals to that of the body 102. In other words, θₜ=θ_{b}. The tine's position (denoted as tₜ), where tₜ=[xₜ, yₜ, zₜ]^{T} may be initialized based on heuristics as

$${x}_{t} = {x}_{b} + {s}_{x} sin {θ}_{b} ( \frac{{d}_{1}}{2} + {s}_{1} ) , \\ {y}_{t} = {y}_{b} + {s}_{y} cos {θ}_{b} ( \frac{{d}_{2}}{2} + {s}_{2} ) , \\ {z}_{t} = {z}_{b} + {z}_{d} \\ {s}_{x} , {s}_{y} = \{ \begin{matrix}1 , 1 & {θ}_{b} ∈ [ 0 , \frac{π}{2} ) \\ - 1 , 1 & {θ}_{b} ∈ [ \frac{π}{2} , π ) \\ - 1 , - 1 & {θ}_{b} ∈ [ π , \frac{3}{2} π ) \\ 1 , - 1 & {θ}_{b} ∈ [ \frac{3}{2} π , 2 π )\end{matrix} \\ {z}_{d} = \{ \begin{matrix}\frac{1}{2} {d}_{3} & if \vert {b}_{bm} - {b}_{tm} \vert < \frac{1}{3} {b}_{bh} \\ & 0 otherwise\end{matrix}$$

where |b_{bm}−bₜₘ| means the absolute value of the pixel difference between the minimum of horizontal axis of b_{b}, bₜ on the image. If this difference is small with respect to the height of b represented by b_{bh}, then the tine 104 is considered lifted and the offset of half the height of the body may be added to zₜ.

The cost function of Equation (1) is described in the following paragraphs. The cuboid c is converted to 8 points {pᵢ} based on the initial position and its dimensions and yaw angle, where pᵢ ∈R³, 1≤i≤8. Each point pᵢ can be reprojected to the image as pᵣ∈R², and the maximum and minimum pixel coordinates of these reprojected points are uₘₐₓ, uₘᵢₙ, uₘₐₓ, uₘᵢₙ respectively.

FIG. 2 shows the reprojection of cuboid 204 points to a 2D image 202. The cuboid 204 may be used to model the body 102 of the forklift 100. The cuboid 204 is reprojected to the 2D image 202 represented by a square. The dots 206 are the reprojected pixel coordinates of the 3D cuboid 204 points. The rectangle 210 represents the bounding box 110. The cost is calculated from the misalignment of the reprojected points with respect to the bounding box 110:

$$cost = {‖ {a}_{m ax} - {u}_{m ax} ‖}_{r} + {‖ {a}_{m i n} - {u}_{m i n} ‖}_{r} + {‖ {b}_{m ax} - {v}_{m ax} ‖}_{r} + {‖ {b}_{m i n} - {v}_{m i n} ‖}_{r} \qquad ( 3 )$$

where aₘₐₓ, aₘᵢₙ, bₘₐₓ, bₘᵢₙ are the maximum and minimum pixel coordinates of bₚ. The jacobians of the cost with respect to c can be obtained via automatic differentiation.

The tine 104 of the forklift 100 may be modelled using an ellipsoid instead of a cuboid since the tine 104 is very thin, and the reprojected corners can be very close to each other. In contrast, the ellipsoid may be constrained using the geometric property of quadrics easily even for thin structures. Suppose Q∈R^{4×4} is the quadric matrix constructed from the ellipsoid state q, then Q is tangent to the plane H, which is the plane of c that touches the tine 104. This provides a constraint:

$$H Q {H}^{⊤} = 0 \qquad ( 4 )$$

Q can be projected to the image to obtain its conic C=PQP^{T}, where P is the projection matrix. The lines lᵢ, j∈[1, 2, 3, 4] may be extracted from bₜ, and for the lines that are entirely visible in the image, the following constraint may be added, where D refers to the dual conic of C:

$${l}_{i} D {1}_{j}^{⊤} = 0 \qquad ( 5 )$$

The Jacobians of the constraints in Equations (4) and (5) with respect to q can also be derived from automatic differentiation. The optimization problem can be solved via the Levenberg-Marquardt (LM) algorithm. The optimization step is summarized in Algorithm 1 as follows:

Algorithm 1 Cuboid State Optimization

| | |
|---|---|
| 1: | Input: Initial c, q |
| 2: | Output: Optimized c, q |
| 3: | Obtain the measurements as described in Sec. 4 |
| 4: | Initialize c based on the inferred yaw, dimensions, and b_{b} |
| 5: | Refine the cuboid position by aligning the bottom center |
| | with the bottom middle point of bounding box |
| 6: | Initialize q based on c and b_{b}, bₜ |
| 7: | Compute the 3D coordinates of the 8 corners |
| 8: | Project the points on the image |
| 9: | Find the minimum and maximum of the 8 projected corners |
| | on the image |
| 10: | Find the residual between reprojected points and b_{b} as |
| | in Eq. 3 |
| 11: | Compute the jacobian between the residual and c |
| 12: | Compute the residual of the quadric constraints in Eq. 4, |
| | Eq. 5 |
| 13: | Compute the jacobian between the residual and q |
| 14: | Optimize c, q using LM |

The body and tine states may be tracked over time given the optimized estimation at each time instance via Kalman Filter with a constant velocity model. An example of the computation can be found in “3D Multi-Object Tracking: A Baseline and New Evaluation Metrics” by Wen et. al., which is incorporated herein by reference. The body 102 and the tine 104 may be tracked as a whole, instead of being tracked as separate objects. The state now becomes:

x=(θ_{b},x_{b},y_{b},z_{b},v_{bx},v_{by},v_{bz},d₁,d₂,d₃,θₜ,xₜ,yₜ,zₜ,vₜₓ,v_{ty},v_{tz},s₁,s₂,s₃)∈R²⁰

The body 102 and the tine 104 may be tracked simultaneously by adding more constraints to the update step:

$${θ}_{b} - {θ}_{t} = 0 \qquad ( 6 )$$

$${v}_{bx} - {v}_{tx} = 0$$

$${v}_{by} - {v}_{ty} = 0$$

$${v}_{bx} - {v}_{tz} = 0$$

which means the yaw angles and velocities of the body and tine should be the same.

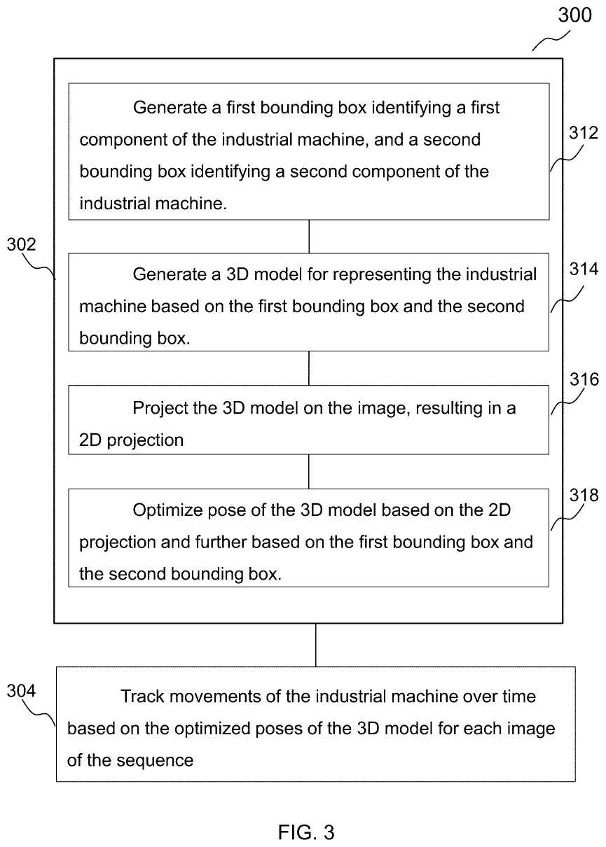

FIG. 3 shows a flow diagram of a computer-implemented method 300 for tracking movements of an industrial machine according to various embodiments. The method 300 may include a process 302 for determining pose of the industrial machine at a single time instance, as captured in an image frame. The process 302 may include determining the pose by optimizing pose of a 3D model that approximates the industrial machine. The process 302 may be repeated for a plurality of images in a sequence of images. The method 300 may further include a process 304 of tracking movements of the industrial machine over time based on the optimized poses of the 3D model for each image of the sequence. An example of the implementation of the method 300 is described in the paragraphs above. The sequence of images may be generated by a camera. The camera may be disposed on a vehicle, autonomous or manually-operated, that operates in the same environment as the industrial machine.

The process 302 may include generating a first bounding box 110 identifying a first component of the industrial machine, and a second bounding box 120 identifying a second component of the industrial machine, in 312. In an example, the first component may be a body 102 of the industrial machine, while the second component may be a movable member of the industrial machine such as the tine 104 of a forklift 100. The process 302 may further include generating a 3D model for representing the industrial machine based on the first bounding box 110 and the second bounding box 120, in 314. The 3D model may include a first geometric shape and a second geometric shape. The first geometric shape may represent the first component. The second geometric shape may represent the second component. The process 302 may further include projecting the 3D model on the image, resulting in a 2D projection, in 316. The process 302 may further include optimizing pose of the 3D model based on the 2D projection, and further based on the first bounding box 110 and the second bounding box 120, in 318.

The method 300 proposes novel heuristics to estimate 3D poses of components of the industrial machine based on 2D detections. For example, the tine position may be initialized based on the relative position of the 2D bounding box of the tine 104 with respect to that of the forklift body 102.

According to an embodiment which may be combined with any of the above-described embodiment or with any below described further embodiment, generating the first bounding box 110 and further generating the second bounding box 120 may include inputting the image to a first neural network trained using a first training dataset. The first training dataset may include images of the industrial machine where the first component and second component are annotated with 2D bounding boxes. The first neural network may be a 2D detector. Such 2D detectors are known in the art, for example, may be implemented using convolutional neural networks (CNN). The first neural network may be trained using training data that includes ground truth 2D images of the industrial machine, with the first component and the second component marked out with bounding boxes. The 2D bounding boxes outline the object of interest within the image by defining its coordinates, making it easier for the neural network to find the object of interest. The annotation of the training data is relatively simple, as compared to that of annotating 3D sensor data. This allows the first neural network to be trained with a large dataset, to yield accurate detections.

According to an embodiment which may be combined with any of the above-described embodiment or with any below described further embodiment, generating the 3D model may include cropping the image according to the first bounding box 110 to result in a region of interest, and estimating size and orientation of the first component based on the region of interest. Estimating size and orientation of the first component may include inputting the region of interest to a second neural network trained using a second training dataset. Inputting the cropped image allows the second neural network to focus on estimating information of only the first component. This improves accuracy of the estimation. The second neural network may be an extension of the first neural network, trained to regress the orientation and dimensions from an image. The second neural network may include a deep CNN. The second training data set may include images of the industrial machine annotated with information on orientation and dimension of the first component. As compared to known methods of tracking 3D object movements, the method 300 only requires annotations consisting of 2D bounding box, yaw angle, and dimensions, which are easily available. This allows for the first and second neural networks to be trained for accurate detection.

According to an embodiment which may be combined with any of the above-described embodiment or with any below described further embodiment, generating the 3D model may include generating the first geometric shape based on the estimated size and orientation of the first component and further based on the first bounding box 110. Using a geometric shape to represent the first components simplifies the modelling process, as the geometric shape is a known, regular, shape that may easily generated with dimensions.

According to an embodiment which may be combined with any of the above-described embodiment or with any below described further embodiment, generating the 3D model may further include refining position of the first geometric shape by aligning a bottom centre of the first geometric shape with a bottom middle point of the first bounding box 110. This alignment process reduces error in the translation of the first geometric shape, so that it may represent the first component more accurately.

According to an embodiment which may be combined with any of the above-described embodiment or with any below described further embodiment, generating the 3D model may further include generating the second geometric shape based on the first geometric shape and further based on each of the first bounding box 110 and the second bounding box 120. The second component may have a shape that is less regular as compared to the first component, such that the first geometric shape may be a closer approximation of the first component. Thus, by using the relative positions of the first and second components and the pose of the first geometric shape as a reference, the second component may be accurately modelled.

According to an embodiment which may be combined with any of the above-described embodiment or with any below described further embodiment, optimizing the pose of the three-dimensional model may include minimizing a misalignment of the two-dimensional projection as compared to the first bounding box and the second bounding box.

According to an embodiment which may be combined with any of the above-described embodiment or with any below described further embodiment, the industrial machine may be a forklift 100. The first component may be a body 102 of the forklift 100, and wherein the second component is a tine 104 of the forklift 100. Forklifts need to move around in warehouses and may move theirs tines 104 often to retrieve or store pallets. The method 300 may be useful for avoiding collisions between forklifts 100 and other machines in warehouses. The first geometric shape may be a cuboid, and the second geometric shape may be an ellipsoid. A cuboid may be a close approximation of the shape of a forklift body 102. The tine 104 is a relatively thin structure. Using a cuboid to model it may result in projected corners that are too close to each other, thereby adversely affecting process 316 of projecting the 3D model on the 2D image. Using an ellipsoid to model the tine 104 avoids the problem.

According to an embodiment which may be combined with any of the above-described embodiment or with any below described further embodiment, the process 302 may further include generating at least one further bounding box identifying a respective at least one further component of the industrial machine. The process 302 may further include generating the 3D model further based on the at least one further bounding box. The 3D model may further include at least one further geometric shape respectively representing the at least one further component. The process 302 may further include optimizing the pose of the 3D model further based on the at least one further bounding box. The at least one further component may include other movable members of the industrial machine, that may require tracking. For example, a cobot arm may include multiple segments. Movements of the at least one further component of the industrial machine may be tracked similarly to that of at least one of the first component and the second component.

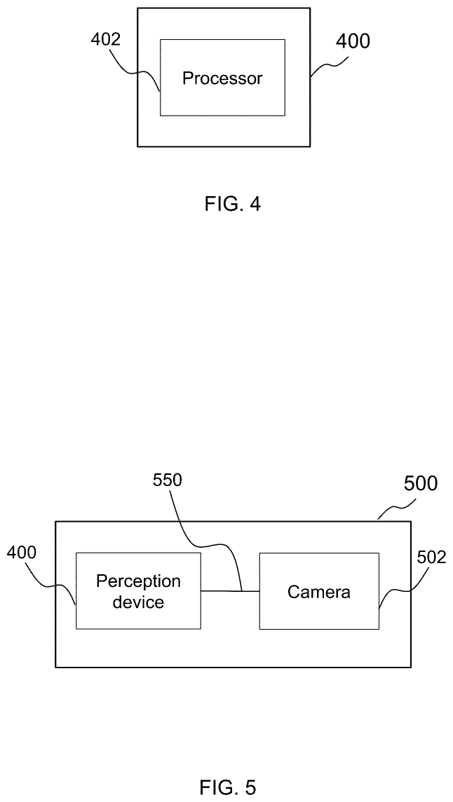

FIG. 4 shows a block diagram of a perception device 400 according to various embodiments. The perception device 400 may include a processor 402 configured to carry out the method 300. The perception device 400 may be useful for generating information about the industrial machine's movements, to other operators that operate close to the industrial machine, for example, another machine or another vehicle.

FIG. 5 shows a block diagram of a robot 500 according to various embodiments. The robot 500 may include the perception device 400 and a camera 502. The perception device 400 and the camera 502 may be coupled at least one of electrically and mechanically, by coupling line 550. The camera 502 may be configured to generate the sequence of 2D images. By processing the 2D images captured by the camera 502, the perception device 400 may determine movements of the industrial machine so that the robot 500 can avoid collisions with the industrial machine.

According to various embodiments, a non-transitory computer-readable medium may be provided. The computer-readable medium may include instructions which, when executed by at least one processor, cause the processor to carry out the method 300. Various aspects described with respect to the perception device 400 or the robot 500 may be applicable to the computer-readable medium.

According to various embodiments, a computer program may be provided. The computer program may include instructions which, when the computer program is executed by a computer, cause the computer to carry out the method 300. Various aspects described with respect to the perception device 400 or the robot 500 may be applicable to the computer program.

While embodiments have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for tracking movements of an industrial machine for each image of a sequence of two-dimensional images that captures the industrial machine comprising:
generating a first bounding box identifying a first component of the industrial machine;
generating a second bounding box identifying a second component of the industrial machine;
generating a three-dimensional model for representing the industrial machine based on the first bounding box and the second bounding box, wherein the three-dimensional model comprises a first geometric shape representing the first component a second geometric shape representing the second component and further comprising;
projecting the three-dimensional model on the image, resulting in a two-dimensional projection; and
optimizing pose of the three-dimensional model based on the two-dimensional projection, and further based on the first bounding box and the second bounding box; and
tracking movements of the industrial machine over time based on the optimized poses of the three-dimensional model for each image of the sequence.

2. The method according to claim 1, wherein generating the first bounding box and further generating the second bounding box further comprises:
inputting the image to a first neural network trained using a first training dataset; and
comprising images of the industrial machine where the first component and second component are annotated with two-dimensional bounding boxes.

3. The method according claim 1, wherein generating the three-dimensional model further comprises:
cropping the image according to the first bounding box to result in a region of interest; and
estimating size and orientation of the first component based on the region of interest.

4. The method according to claim 3, wherein estimating size and orientation of the first component further comprises inputting the region of interest to a second neural network trained using a second training dataset comprising images of the industrial machine annotated with information on orientation and dimension of the first component.

5. The method according to claim 4, wherein generating the three-dimensional model further comprises:
generating the first geometric shape based on the estimated size; and
orientation of the first component and further based on the first bounding box.

6. The method according to claim 5, wherein generating the three-dimensional model further comprises refining position of the first geometric shape by aligning a bottom center of the first geometric shape with a bottom middle point of the first bounding box.

7. The method according to claim 5, wherein generating the three-dimensional model further comprises generating the second geometric shape based on the first geometric shape and further based on each of the first bounding box and the second bounding box.

8. The method according to claim 1, wherein optimizing the pose of the three-dimensional model comprises minimizing a misalignment of the two-dimensional projection as compared to the first bounding box and the second bounding box.

9. The method according to claim 1, wherein the industrial machine is a forklift.

10. The method according to claim 9, wherein the first component is a body of the forklift, and wherein the second component is a tine of the forklift.

11. The method according to claim 10, wherein the first geometric shape is a cuboid, and wherein the second geometric shape is an ellipsoid.

12. The method according to claim 1, further comprising for each image of the sequence of two-dimensional images that captures the industrial machine:
generating at least one further bounding box identifying a respective at least one further component of the industrial machine,
generating the three-dimensional model further based on the at least one further bounding box, wherein the three-dimensional model further comprises at least one further geometric shape respectively representing the at least one further component, and
optimizing the pose of the three-dimensional model further based on the at least one further bounding box.

13. A perception device comprising:
a processor for each image of a sequence of two-dimensional images for tracking movements of an industrial machine configured to carry out the steps of;
generating a first bounding box identifying a first component of the industrial machine;
generating a second bounding box identifying a second component of the industrial machine;
generating a three-dimensional model for representing the industrial machine based on the first bounding box and the second bounding box, wherein the three-dimensional model comprises a first geometric shape representing the first component and further comprises a second geometric shape representing the second component;
projecting the three-dimensional model on the image, resulting in a two-dimensional projection;
optimizing pose of the three-dimensional model based on the two-dimensional projection, and further based on the first bounding box and the second bounding box; and
tracking movements of the industrial machine over time based on the optimized poses of the three-dimensional model for each image of the sequence.

14. The perception device of claim 13, further comprising a camera configured to generate the sequence of two-dimensional images.

15. A computer program comprising instructions, which, when the program is executed by a computer, cause the computer to carry out for each image of a sequence of two-dimensional images for tracking movements of an industrial machine the method of:
generating a first bounding box identifying a first component of the industrial machine;
generating a second bounding box identifying a second component of the industrial machine;
generating a three-dimensional model for representing the industrial machine based on the first bounding box and the second bounding box, wherein the three-dimensional model comprises a first geometric shape representing the first component and further comprises a second geometric shape representing the second component;
projecting the three-dimensional model on the image, resulting in a two-dimensional projection;
optimizing pose of the three-dimensional model based on the two-dimensional projection, and further based on the first bounding box and the second bounding box; and
tracking movements of the industrial machine over time based on the optimized poses of the three-dimensional model for each image of the sequence.

16. The computer program of claim 15, wherein the program is executable by at least one processor having non-transitory computer-readable storage medium for storing the instructions.
